(19) United States
(12) Patent Application Publication
(10) Pub. No.: US 2011/0228857 A1
(43) Pub. Date: Sep. 22, 2011

(54) Video data processing apparatus, video data processing method, and program

(75) Inventors: Makoto Daido, Tokyo (JP); Hiroshi Mizuno, Nagano (JP); Kazuyoshi Takahashi, Tokyo (JP)

(73) Assignee: Sony Corporation, Tokyo (JP)

(21) Appl. No.: 12/931,271

(22) Filed: Jan. 27, 2011

(30) Foreign Application Priority Data
Feb. 5, 2010 (JP) P2010-023989

(51) Int. Cl. H04N 7/26

(52) U.S. Cl. 375/240.25; 375/E07.027

(57) ABSTRACT

There is provided a video data processing apparatus including an encoder and a synthesis processor. The encoder is configured to compression-encode input uncompressed video data, to thereby generate compressed video data. The synthesis processor is configured to uncompression-decode the compressed video data generated by the encoder, to thereby obtain decoded video data having a time range, to obtain uncompressed video data of a time range same as the time range of the decoded video data, and to generate synthesized video data in which a video image of the decoded video data and a video image of the uncompressed video data are displayed in sync with each other and in parallel to each other on one display screen.

### CROSS-REFERENCE TO RELATED APPLICATION

The present application claims priority from Japanese Patent Application No. JP 2010-023989 filed in the Japanese Patent Office on Feb. 5, 2010, the entire content of which is incorporated herein by reference.

### BACKGROUND OF THE INVENTION

1. Field of the Invention

The present invention relates to a video data processing apparatus, a video data processing method, and a program, for example, to compression-encoding of video data in an authoring process of an optical disc or the like.

2. Description of the Related Art

For example, in manufacturing play-only discs (BD-ROM) and the like of Blu-ray Disc (registered trademark, hereinafter, referred to as “BD”), a flow of manufacturing optical discs using an authoring system for producing contents to be recorded will be briefly descried with reference to FIG. 6.

First, to produce materials, video image materials are picked up, sound materials are recorded, they are edited, and the like (S1).

The picked up and edited data and the like are stored as material data (video image material, sound material, subtitle data, and the like) of contents to be produced (S2).

The various kinds of material data are supplied to an authoring studio, and used to produce disc data (contents).

In the authoring studio, by using a personal computer or predetermined hardware in which a program for authoring processing is installed, contents are produced using the various kinds of material data.

Video image materials and sound materials are video-encoded and audio-encoded to thereby be compression-decoded in predetermined formats, respectively. Further, from the subtitle data and the like, menu data, subtitle data, and the like are produced (S3). Next, as a structure of the contents, a scenario and a menu are produced (S4). Further, various kinds of data are edited (S5).

After that, as multiplexer processing (S6), stream data structuring the contents is produced. The multiplexer processing is to multiplex the encoded video image data, sound data, menu, and the like. In this case, for example, encoded material data such as image, sound, and subtitle stored in a hard disk and the like is interleaved, and multiplexing processing is performed to produce data merged with various kinds of format files and multiplexed.

The eventually-produced multiplexed data is, as a cutting master to manufacture discs, for example, stored in a hard disk and the like in a personal computer.

The cutting master is transferred to a factory to manufacture discs (S7).

In the factory, as premastering (S8), various kinds of data processing are performed such as encrypting data and encoding disc-recorded data, to thereby produce mastering data. Further, as mastering (S9), processes from cutting a disc master to manufacturing a stamper are performed. Finally, as replication (S10), a disc substrate is manufactured by using the stamper, and a predetermined layer structure is formed on the disc substrate, to thereby obtain an optical disc (BD-ROM) as a finished product.

### SUMMARY OF THE INVENTION

As described above, in a manufacturing field of package media such as optical discs, video data, audio data, and the like are data-compressed (S3) by applying MPEG (Moving Picture Experts Group) technique, respectively, after that, are multiplexed, and are recorded in a various kinds of media.

In an authoring apparatus, in the processing of video encoding and audio encoding (S3), a bit amount capable of recording in a medium is allocated for video data, audio data, and the like, and the video data and the audio data are data-compressed such that they are fallen in the allocated bit amounts, respectively.

In this case, with regard to the video data, according to a bit amount generated by data compression under a certain data compression condition, the bit amount allocated to the video data is distributed to respective frames. Respective frame data is constituted by GOP (Group Of Picture) units to which intra-frame encoding or inter-frame encoding processing is performed.

In general, with regard to compression of video data, after compression is finished, the compressed video data is compared with uncompressed video data to confirm degradation degree of image quality, a compression parameter or bits are re-allocated, and the compression operation is repeated until the degradation degree of image quality is fallen in an acceptable range.

In this case, it is necessary to compare the uncompressed video data and the video data after compression.

However, a frame may be dropped from the uncompressed video data if a recording apparatus storing the data does not exhibit high speed enough.

Further, the video data after compression has a characteristic of generation of delay because of intra-frame compression.

Further, in data compression using an AVC codec standardized under ISO/IEC 14496-10, complicated calculation processing is required to decode data, and a frame may be dropped in the case of a computing apparatus whose processing capacity is low.

In a conventional authoring apparatus, due to those problems, it is extremely difficult to simultaneously display uncompressed video data and video data after compression in sync with each other to be compared.

The present invention has been made in view of the above-mentioned circumstances, and the present invention relates to a data processing apparatus capable of displaying divided uncompressed video data and divided video data after compression in sync with each other on one screen, which allows effective processing of video data.

A video data processing apparatus according to an aspect of the present invention includes an encoder and a synthesis processor. The encoder is configured to compression-encode input uncompressed video data, to thereby generate compressed video data. The synthesis processor is configured to uncompression-decode the compressed video data generated by the encoder, to thereby obtain decoded video data having a time range, to obtain uncompressed video data of a time range same as the time range of the decoded video data, and to generate synthesized video data in which a video image of the decoded video data and a video image of the uncompressed video data are displayed in sync with each other and in parallel to each other on one display screen.

The synthesis processor supplies the synthesized video data to a display apparatus to be displayed.

Further, the synthesis processor supplies the synthesized video data to a storage to be stored.

In this case, the video data processing apparatus further includes a division synthesis processor configured to read the synthesized video data stored in the storage, to synthesize part of the video image of the decoded video data and part of the video image of the uncompressed video data in the read synthesized video data, to generate division-synthesized video data in which the parts are merged, and to supply the division-synthesized video data to the display apparatus to be displayed.

A video data processing method according to an aspect of the present invention includes compression-encoding uncompressed video data, to thereby generate compressed video data, and uncompression-decoding the compressed video data obtained in the encoding step, to thereby obtain decoded video data having a time range, and generating synthesized video data in which a video image of the decoded video data and a video image of the uncompressed video data of a time range same as the time range of the decoded video data are displayed in sync with each other and in parallel to each other on one display screen.

A program according to an aspect of the present invention is a program causing an arithmetic processing unit to execute the respective steps.

That is, according to the aspects of the present invention, video data is compression-encoded, and after that, the compressed video data is uncompression-decoded, to thereby obtain decoded video data. Further, the decoded video data and uncompressed video data of the same time range are synthesized. The synthesized image data is video data in which the video image of the decoded video data and the video image of the uncompressed video data, that is, the same video images, are displayed in sync with each other and in parallel to each other on one display screen. In the case of displaying the above-mentioned synthesized image data, the video images before/after compression are displayed in sync with each other and in parallel to each other on one screen.

Alternatively, also in the case of synthesizing part of the video image of the decoded video data and part of the video image of the uncompressed video data, generating the division-synthesized video data being a video image in which the parts are merged, and displaying the division-synthesized video data, the video images before/after compression are displayed on one screen.

According to the aspects of the present invention, it is possible to easily perform image quality comparison of uncompressed video data and video data after compression, which has been difficult to perform, and easily define a point whose image quality is degraded. Therefore, efficiency of the video compression process in the authoring working process is improved.

These and other objects, features and advantages of the present invention will become more apparent in light of the following detailed description of best mode embodiments thereof, as illustrated in the accompanying drawings.

### BRIEF DESCRIPTION OF THE DRAWINGS

FIG. 1 is a block diagram showing an authoring apparatus according to an embodiment of the present invention;

FIG. 2 is a flowchart showing a first processing example of a video data processing apparatus of this embodiment;

FIGS. 3 are explanatory diagrams showing functions of a decode control unit of this embodiment;

FIG. 4 is a flowchart showing a second processing example of the video data processing apparatus of this embodiment;

FIGS. 5 are explanatory diagrams showing functions of the decode control unit of this embodiment; and

FIG. 6 is an explanatory diagram showing manufacturing processes of optical discs.

### DETAILED DESCRIPTION

Hereinafter, an embodiment of the present invention will be described in the following order.

### (1. Authoring Apparatus Structure)

(2. First Processing Example)

(3. Second Processing Example)

(4. Program)

### (1. Authoring Apparatus Structure)

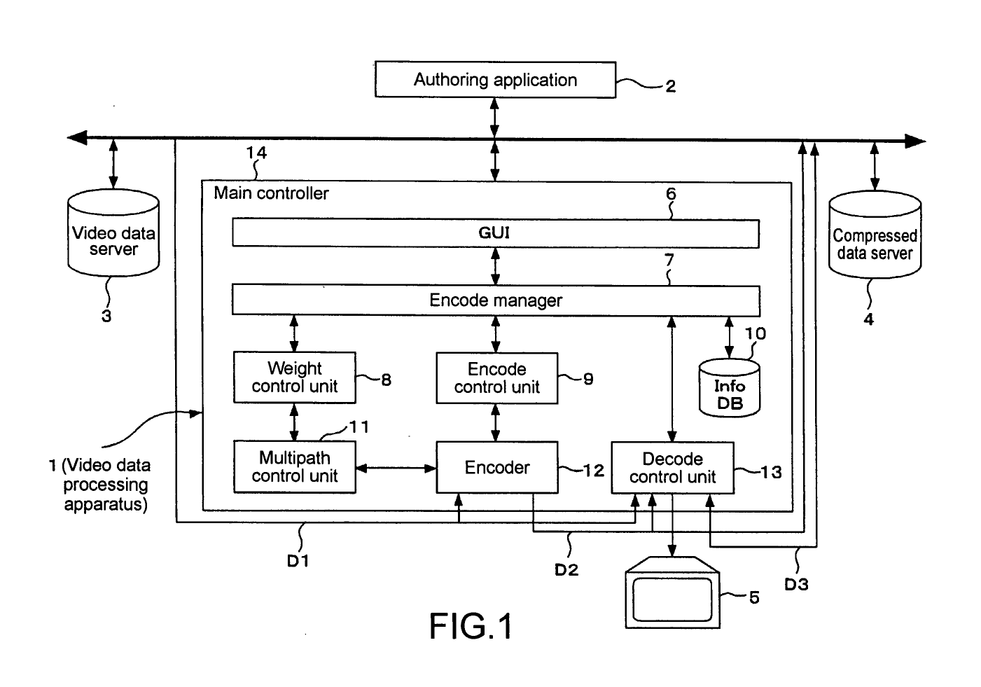

FIG. 1 is a block diagram showing an authoring apparatus of this embodiment, specifically, part in relation with video encoding. Here, a video data processing apparatus 1, an authoring application 2, a video data server 3, a compressed data server 4, and a monitor apparatus 5 are shown.

The video data processing apparatus 1 is, for example, embodied by hardware being a computer apparatus and software run in the computer apparatus. As is well known, a computer is structured by including a CPU (Central Processing Unit), a ROM (Read Only Memory), a RAM (Random Access Memory), an interface unit to an external apparatus, and the like.

The authoring application 2 is application software causing the authoring apparatus to execute the entire behaviors, and controls, corresponding to external input operations and the like, behaviors necessary for the authoring processing using the computer apparatus being the network-connected video data processing apparatus 1.

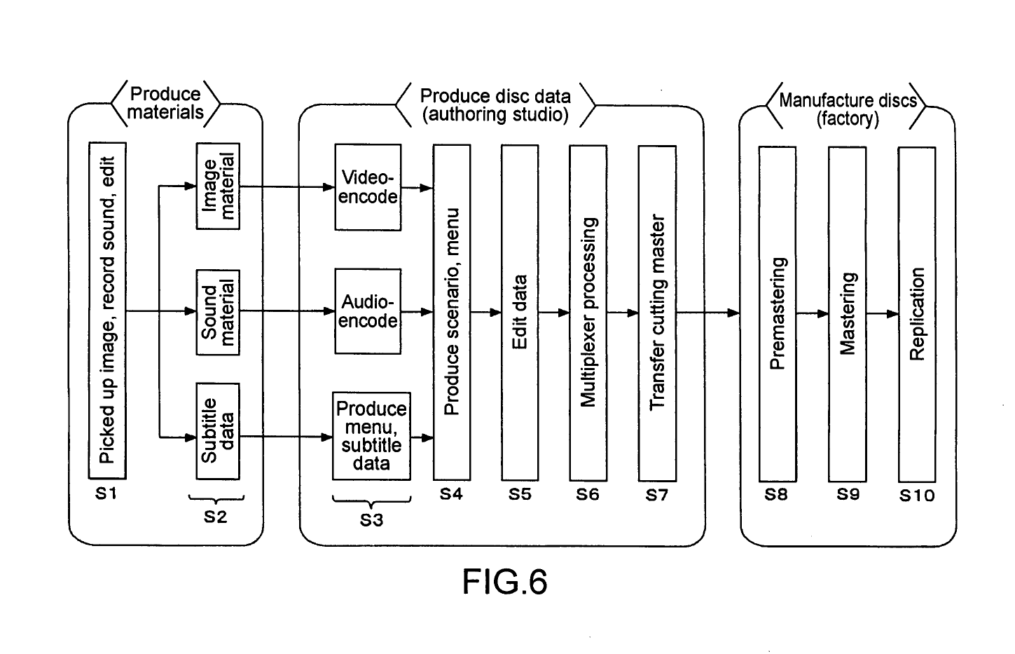

For example, the software controls and executes the various kinds of processing of the procedures S3-S7 described with reference to FIG. 6. Here, specifically, the software controls the entire video encode processing.

The authoring application 2 runs in a main control apparatus (not shown) controlling the entire authoring system, and instructs behaviors of the computer apparatus assigned as the video data processing apparatus 1 performing encode processing of the examples. Note that, the authoring application 2 may run in the computer apparatus being the video data processing apparatus 1.

The video data server 3 stores video data being video image materials before performing compression-encoding (in the description, referred to as “uncompressed video data”). Further, the video data server 3 also stores synthesized video data (described later).

The compressed data server 4 stores video data to which the compression-encoding is performed (“compressed video data”).

The video data server 3 and the compressed data server 4 are embodied by, for example, a hard disk drive (HDD).

The HDD being the video data server 3 and the compressed data server 4 may be accommodated in the computer apparatus being the video data processing apparatus 1 or connected, as an external apparatus, to the video data processing apparatus 1.

The monitor apparatus 5 is a display device performing display output of a video image of video data supplied from the video data processing apparatus 1. In the examples, as described later, synthesized video data in which the uncompressed video data and the compressed video data are synthesized is displayed.

FIG. 1 shows a main controller 14 as the video data processing apparatus 1, and various kinds of functional blocks in the main controller 14. In other words, the main controller 14 shows behavior functions of the video data processing apparatus 1.

The main controller 14 performs control/execution of the entire video encode processing, and is structured by a computer apparatus assigned as the video data processing apparatus 1.

The main controller 14 performs data communication with the authoring application 2 via a network of the authoring system, to thereby control behaviors of the entire video data processing apparatus 1.

As the functional blocks in the main controller 14 in relation with the behaviors of the examples, a GUI (Graphical User Interface) unit 6, an encode manager 7, a weight control unit 8, an encode control unit 9, an Info database 10, a multipath control unit 11, an encoder 12, and a decode control unit 13 are shown.

The GUI unit 6 displays input icons and the like on a screen of the monitor apparatus 5, and performs processing corresponding to input operations.

The encode manager 7 controls behaviors of the weight control unit 8, the encode control unit 9, and the decode control unit 13.

The weight control unit 8 generates data necessary for calculation by the multipath control unit 11. For example, the weight control unit 8 controls data and the like of bit allocation in compression processing.

The encode control unit 9 controls the encoder 12.

The Info database 10 stores data and the like obtained by the encode manager 7.

The multipath control unit 11 calculates a target bit amount.

The encoder 12 performs compression-encoding to video data.

The decode control unit 13 uncompression-decodes to compression-encoded video data, generates synthesized video data and division-synthesized video data (described later), controls outputting display data to the monitor apparatus 5, and the like.

In encoding in the above-mentioned video data processing apparatus 1, the respective units behave as follows.

The video data server 3 stores uncompressed video data.

Based on the reproduction control, the video data server 3 reproduces and outputs uncompressed video data D1 of a processing target. The uncompressed video data D1 is supplied to the encoder 12.

According to conditions notified by the authoring application 2, the encoder 12 switches behaviors controlled by the encode manager 7 and the encode control unit 9, and performs data compression of the uncompressed video data D1 output by the video data server 3.

Further, in the above-mentioned encoding processing, the encoder 12 notifies the encode manager 7 of an encode processing result. Therefore, the encode manager 7 is capable of understanding a picture type determined in the data compression and a generated bit amount per frame unit.

Further, in a compression processing for preliminary difficulty measure, the encoder 12 determines the picture type in the internal processing, performs data compression to the uncompressed video data Dl, and notifies the encode manager 7 of a processing result.

Meanwhile, in the eventual data compression processing, the encoder 12 supplies video data D2 to which data compression processing is performed by assigning a picture type and a target bit amount per frame in the encode control unit 9 to the compressed data server 4 to cause the compressed data server 4 to record. Further, the encoder 12 notifies the encode manager 7 of the recorded data amount and the like.

The encode manager 7 stores the various kinds of data obtained as described above in the Info database 10.

The decode control unit 13 decompresses the uncompressed video data D1 recorded in the video data server 3 and the compressed video data D2 recorded in the compressed data server 4. The monitor apparatus 5 is structured so as to display those data on a monitor.

Therefore, in the video data processing apparatus 1, with the monitor apparatus 5, it is possible to confirm and so-called preview the uncompressed video data and the video data being the processing result of the data compression as necessary. Further, based on the preview result, it is possible to perform minor changes of detailed conditions of encoding.

Further, the decode control unit 13 is capable of producing, with regard to an arbitrary time range assigned by an operator, synthesized video data D3 in which the uncompressed video data D1 and the data being the decoded compressed video data D2 of this time range are merged into one file. Further, the decode control unit 13 is capable of causing the video data server 3 to store the produced synthesized video data D3 and outputting the produced synthesized video data D3 to the monitor apparatus 5 to be displayed.

The monitor apparatus 5 is capable of, in a case where the synthesized video data D3 is supplied, performing division display of an image at an assigned ratio, which allows to compare image quality.

The entire main controller 14 receives, managed by the GUI unit 6, controls by the authoring application 2, receives operations by an operator, and controls behaviors of the encoder 12 by using the encode manager 7 and the encode control 9 managed by the GUI unit 6.

That is, the entire main controller 14 performs encode processing to the processing target according to the conditions notified by the authoring application 2. Further, the entire main controller 14 notifies the authoring application 2 of the processing result. Further, the entire main controller 14 is capable of receiving settings by an operator via the GUI unit 6, and changing the detailed conditions of encoding.

The encode control unit 9 controls the video data file in the video data server 3 according to an edit list notified by the authoring application 2, and reproduces a predetermined edit target.

Further, the weight control unit 8 similarly determines conditions of encode processing of each encode unit according to an encoded file VENC. XML notified by the authoring application 2, and notifies the multipath control unit 11 of the control data under those conditions.

In this case, the multipath control unit 11 changes the settings of bit allocation in the encode processing and the set conditions in response to operations by an operator.

The encode control unit 9 controls, according to the control file notified by the multipath control unit 11, encoding behaviors of the encoder 12. Further, the encode control unit 9 controls such that data of difficulty required to each encode processing is notified per frame unit, and the compressed video data D2 is recorded in the compressed data server 4.

### (2. First Processing Example)

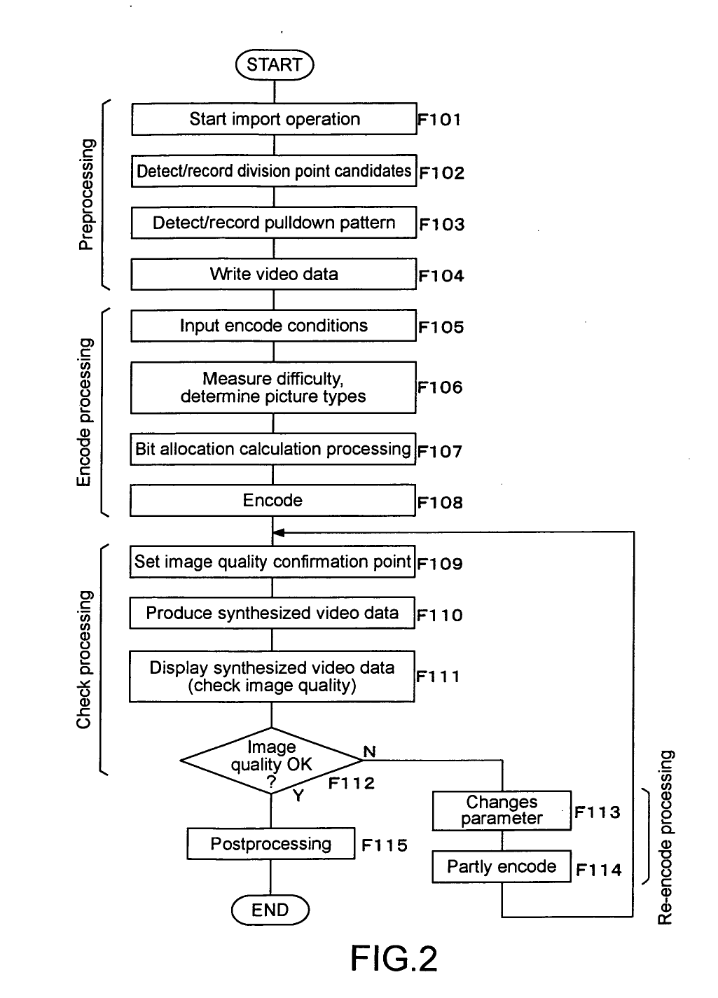

FIG. 2 shows a first processing example of processing of the compression-encoding in this embodiment.

The processing of the compression-encoding roughly includes preprocessing, encode processing, check processing, and postprocessing, and in some cases, re-encode processing is performed.

First, as the preprocessing, Steps F101-F104 are performed.

In Step F101, based on an instruction by the authoring application 2 according to the GUI operations by an operator, import of video data being video image materials is started. That is, this is processing to store the uncompressed video data in the video data server 3. A reproducing apparatus (not shown) reproduces the video data being the video image materials. The video data is supplied to the video data server 3 via the network of the authoring system to be recorded.

While performing the import behaviors, Steps F102, F103, and F104 are performed.

In Step F102, division point candidates are detected and recorded. The division points are, in the video data being a series of temporally-continuous video image materials, division points set in a case of encoding by dividing into a plurality of times for convenience of encode processing.

In Step F103, a pulldown pattern is detected and recorded. This is detection/recording of pulldown information of video data being imported.

In the video data writing in Step F104, video data and attached information are recorded in a video data server.

In the above-mentioned preprocessing, the uncompressed video data to which the encode processing is performed is stored in the video data server 3.

In Steps F105-F108, the encode processing is performed.

First, in Step F105, according to encode conditions input by an operator, the encode manager 7 sets encode conditions.

In Step F106, difficulty of compression-encoding is measured, and an I picture, a P picture, and a B picture are determined as picture types.

The encode manager 7 understands them based on the processing by the encoder 12 and the weight control unit 8.

Further, in Step F107, the encode manager 7 performs bit allocation calculation processing based on the difficulty, the picture types, and the setting conditions. As a result, the encode manager 7 notifies the encode control unit 9, the weight control unit 8, and the multipath control unit 11 of the determined setting conditions, picture types, bit allocations, and the like.

Further, in Step F108, based on those conditions, the encoder 12 performs actual compression-encoding processing.

That is, the encode control unit 9 causes the video data server 3 to reproduce the uncompressed video data D1, and causes the encoder 12 to perform compression-encoding to the uncompressed video data D1. Further, the encode control unit 9 controls to store the compression-encoded compressed video data D2 in the compressed data server 4.

After the encode processing is finished, in the case where the compressed video data D2 with regard to the target video data range is stored in the compressed data server 4, the check processing of Steps F109-F112 is performed.

The check processing is processing in which video data before/after compression are actually displayed, which allows to check an image quality after compression.

In Step F109, according to an input by an operator, the encode manager 7 sets an image quality confirmation point.

An operator is capable of assigning, with regard to the video data to which the compression processing is performed, an arbitrary time range as an image quality confirmation point. That is, in the compressed video data D2, it is possible to assign a time range (time code range) to be confirmed. The encode manager 7 sets, according to the input by an operator, a time range being a check point.

Next, in Step F110 , with regard to the video data of the time range set as the image quality confirmation point, synthesized video data D3 is produced.

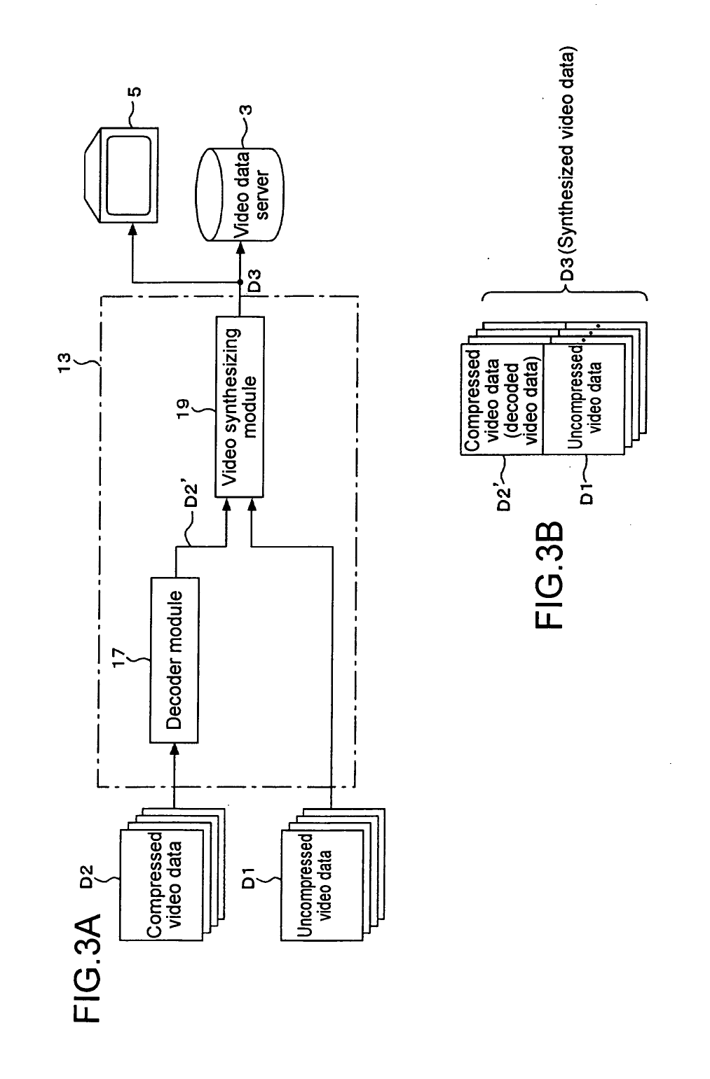

The decode control unit 13 produces the synthesized video data D3. To produce the synthesized video data D3, the decode control unit 13 has functions of a decoder module 17 and a video synthesizing module 19 shown in FIG. 3A.

The encode manager 7 causes the decode control unit having those functions to produce the synthesized video data D3 of the time range being the image quality confirmation point.

First, the encode manager 7 causes the compressed data server 4 to reproduce the compressed video data D2 of the time range and to supply to the decode control unit 13. As shown in FIG. 3A, in the decode control unit 13, the decoder module 17 decodes (decompression processing with respect to compression) the compressed video data D2, to thereby obtain decoded video data D2′.

Further, the encode manager 7 causes the video data server 3 to reproduce the uncompressed video data D1 of the time range and to supply to the decode control unit 13.

In the decode control unit 13, the uncompressed video data D1 and the decoded video data D2′ decoded by the decoder module 17 are supplied to the video synthesizing module 19, and synthesis processing is performed.

The video synthesizing module 19 synthesizes the decoded video data D2′ and the uncompressed video data D1 in frame sync with each other, and generates the synthesized video data D3 of FIG. 3B in which, for example, two images are merged vertically.

The encode manager 7 transfers the synthesized video data D3 generated as described above to the video data server 3 to be stored. That is, the synthesized video data D3 being video data of twice the size of the uncompressed video data D1 in the vertical direction is stored. Note that, in this case, it is possible to directly transfer the generated synthesized video data D3 to the monitor apparatus 5 to be displayed.

Further, the synthesized video data D3 may not be stored in the video data server 3, but may be stored in another recording medium, for example, in the compressed data server 4 side.

After the synthesized video data D3 is generated and stored in the video data server 3 as described above in Step F110 , subsequently, in Step F111, the synthesized video data D3 is displayed.

That is, the encode manager 7 causes the video data server 3 to reproduce the synthesized video data D3 and to supply the synthesized video data D3 to the decode control unit 13. The decode control unit 13 transfers the synthesized video data D3 to the monitor apparatus 5 to be displayed.

That is, as shown in FIG. 3B, the monitor apparatus 5 displays a video image in which video images of the same time range, that is, the decoded video data D2′ from the compressed video data D2 and the uncompressed video data D1, are displayed vertically in parallel to each other.

Note that, the monitor apparatus 5 performs, according to an aspect ratio of the monitor display screen, reduced display and the like of the synthesized video data D3 such that the two parallel screens are simultaneously displayed.

According to the above-mentioned display, an operator is capable of simultaneously comparing the images before/after compression by using one screen, and easily checking the image quality after compression.

In a case where the image quality is OK, an operator performs an input operation of check OK (encoding finished). Accordingly, the encode manager 7 proceeds from Step F112 to Step F115, and, as the postprocessing, performs necessary processing such as confirmation of the compressed video data D2 being the encode result, and finishes the series of encode operations.

Meanwhile, in a case where the image quality is unsatisfactory, the operator is capable of instructing re-encoding an arbitrary time range in the compressed video data D2. In this case, in Step F113, the encode manager 7 changes, according to the input by the operator, parameters of the encode processing. Further, in Step F114, the encode manager 7 causes, with regard to the assigned time range, the encoder 12 to perform the encode processing. That is, the encode manager 7 and the encode control unit 9 cause the video data server 3 to reproduce the uncompressed video data D1 with regard to the assigned time range and to supply to the encoder 12, and cause the encoder 12 to perform compression-encoding. Further, the encode manager 7 and the encode control unit 9 cause the compressed data server 4 to store the obtained compressed video data D2. That is, in this case, part of the series of compressed video data D2 stored in the compressed data server 4 is replaced by part of the compressed video data D2 of the time range to which the re-encoding is performed.

After the above-mentioned re-encoding is performed, the check processing of Step F109 and after is similarly performed.

As described above, in this embodiment, in the check processing, the decode control unit 13 uncompression-decodes the compressed video data D2 to thereby obtain the decoded video data D2′, and obtains the uncompressed video data D1 whose time range is same as that of the decoded video data D2′ from the video data server 3. Further, the synthesized video data D3 being a video image in which the video image of the decoded video data D2′ and the video image of the uncompressed video data D1 are vertically displayed in sync with each other and in parallel to each other on one display screen is generated. The above-mentioned synthesized video data D3 is once stored in the video data server 3, after that, reproduced, and displayed on the monitor apparatus 5. Therefore, an operator is capable of comparing the video images before/after compression extremely easily, and performing image quality check with regard to compression-encoding easily and effectively. By simultaneously displaying images in sync with each other, a point whose image quality is degraded is easily defined.

Therefore, efficiency of the video compression process in the authoring working process is extremely improved.

### (3. Second Processing Example)

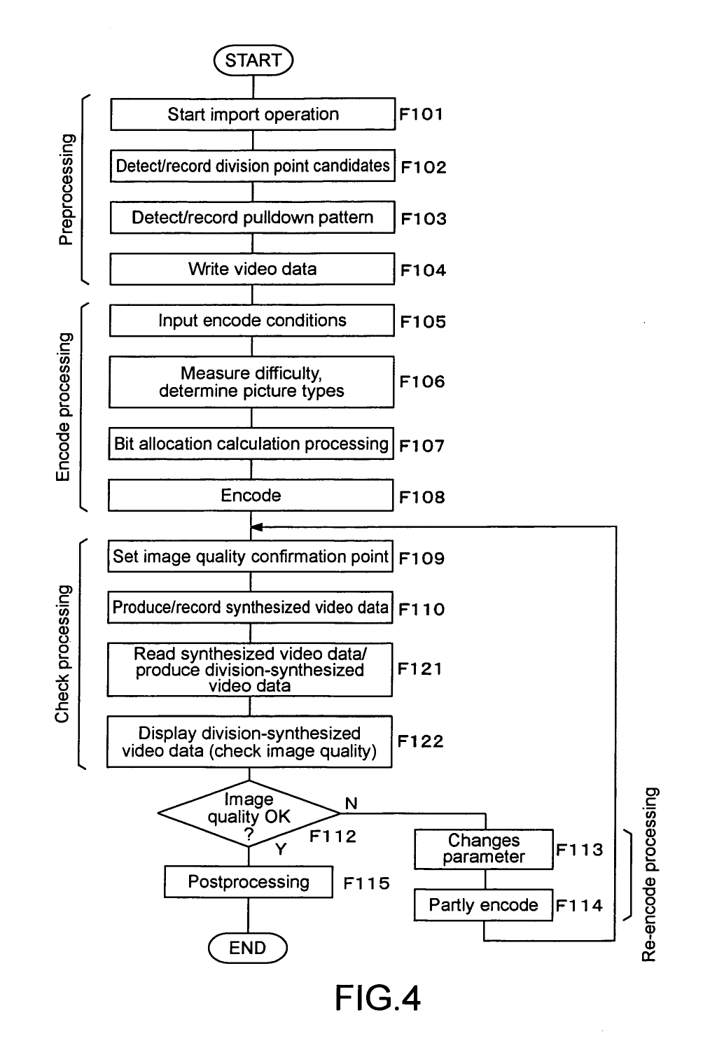

FIG. 4 shows a second processing example. Note that, in FIG. 4, the preprocessing of Steps F101-F104, the encode processing of Steps F105-F108, the re-encode processing of Steps F113-F114, and the postprocessing of Step F115 are similar to those of FIG. 2, so the description thereof will be omitted. Here, the check processing of Steps F109, F110, F121, F122, and F112 will only be described.

After the encode processing of Step F108 is finished, in Step F109, according to an input by an operator, the encode manager 7 sets a time range (time code range) being an image quality confirmation point.

In Step F110, with respect to the video data of the time range set as the image quality confirmation point, the synthesized video data D3 is produced.

Also in this case, the decode control unit 13 has functions of the decoder module 17 and the video synthesizing module 19 shown in FIG. 3A, and produces, similar to the first processing example 1, the synthesized video data D3 shown in FIG. 3B.

The encode manager 7 transfers the synthesized video data D3 generated as described above to the video data server 3 to be stored.

Next, in Step F121, division-synthesized video data is produced.

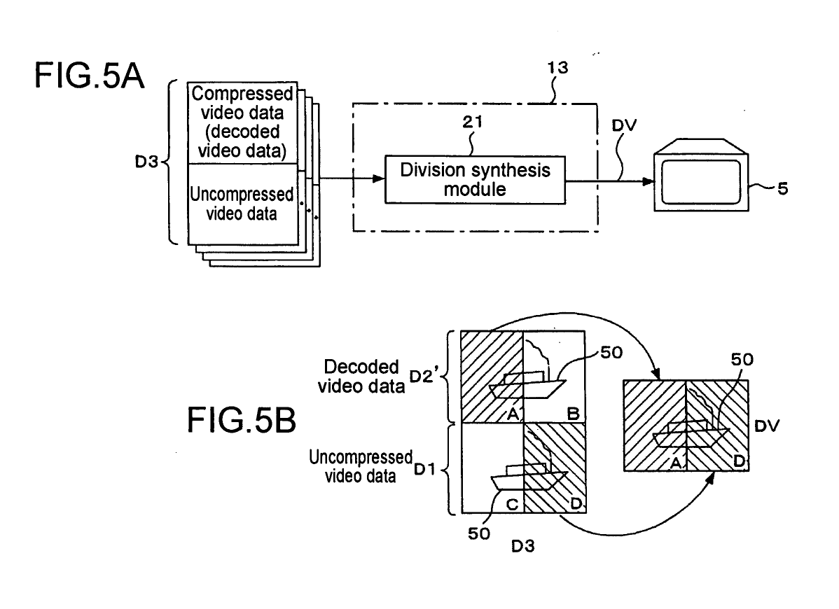

The decode control unit 13 produces division-synthesized video data. As shown in FIG. 5A, to produce division-synthesized video data DV, the decode control unit 13 has a function of a division synthesis module 21. That is, in performing the second processing example, the decode control unit 13 includes, in addition to the decoder module 17 and the video synthesizing module 19 shown in FIG. 3A, the division synthesis module 21 of FIG. 5A.

The encode manager 7 causes the video data server 3 to supply the synthesized video data D3 to the decode control unit 13 including the division synthesis module 21.

As shown in FIG. 5A, in the decode control unit 13, the synthesized video data D3 is supplied to the division synthesis module 21, and division synthesis processing is performed.

The division synthesis includes the following processing.

As shown in FIG. 5B, the synthesized video data D3 is data in which the decoded video data D2′ and the uncompressed video data Dl are merged in frame sync with each other.

Here, the image of the synthesized video data D3 is divided into areas A, B, C, and D. That is, the area of the decoded video data D2′ is divided side-to-side into the two areas A and B, and further, the area of the uncompressed video data D1 is divided side-to-side into the two areas C and D.

Then, the areas A and D are merged side-to-side, to thereby generate a new synthesized image.

The above-mentioned division synthesis processing is performed, and the division-synthesized video data DV is produced.

In Step F121, the division-synthesized video data DV is generated as described above, and in Step F122, the division-synthesized video data DV is transferred to the monitor apparatus 5 to be displayed.

That is, as shown in the division-synthesized video data DV of FIG. 5B, a video image including the decoded video data D2′ as the left-half and the uncompressed video data D1 as the right-half is displayed on the monitor apparatus 5.

By displaying the above-mentioned division-synthesized video data DV, an operator is capable of effectively performing image quality check.

First, in the case where the synthesized video data D3 is displayed as it is, since the synthesized video data D3 is data in which two screen contents are merged in parallel to each other, the synthesized video data D3 is required to be downsized to some extent when displayed on the monitor apparatus 5.

Meanwhile, the division-synthesized video data DV is a video image in which part of the video image of the decoded video data D2′ and part of the video image of the uncompressed video data D1 in the synthesized video data D3 are synthesized and the respective parts are merged, and is fallen in one screen size. In this case, the screen of the monitor apparatus 5 is capable of being used as wide as possible to display. Therefore, large images before/after compression without being downsized can be compared.

An operator may confirm the above-mentioned displayed division-synthesized video data DV, and determine if the encoding is OK or the re-encode processing is to be performed.

Note that, various modes of division and synthesis may be applied to the division synthesis processing.

For example, instead of merging the areas A and D of FIG. 5B, the areas B and D may be merged.

Further, the decoded video data D2′ and the uncompressed video data D1 may be divided into two areas vertically, respectively, and predetermined areas may be extracted therefrom, respectively, to be merged.

As a matter of course, the decoded video data D2′ and the uncompressed video data D1 may be divided into three or more areas, respectively, and predetermined areas may be extracted therefrom, respectively, to be merged.

Further, in the division-synthesized video data DV, the area occupied by the video image of the decoded video data D2′ and the area occupied by the video image of the uncompressed video data D1 may be the same or different. The borderline of the video image of the decoded video data D2′ and the video image of the uncompressed video data D1 may be set according to an input by an operator.

As described above, the way of division and the selection of divided areas to be merged may be arbitrarily selected, as long as the decoded video data D2′ and the uncompressed video data D1 are displayed on one screen, which allows to compare image quality.

### (4. Program)

A program according to this embodiment causes an arithmetic processing unit (main controller 14 and the like) such as a CPU to perform the processing behaviors of FIG. 2 or FIG. 4 according to this embodiment.

That is, the program of this embodiment causes the arithmetic processing unit to perform compression-encoding to uncompressed video data, to thereby generate compressed video data. Further, the program causes the arithmetic processing unit to uncompression-decode the compressed video data obtained in the encoding step, to thereby obtain decoded video data, and generate synthesized video data being video image in which a video image of the decoded video data and a video image of the uncompressed video data of the time range same as the time range of the decoded video data are displayed in sync with each other and in parallel to each other on one display screen.

The program of this embodiment may be previously recorded in a computer apparatus, a HDD being a recording medium embedded in an apparatus on an authoring system, a ROM in a microcomputer including a CPU, and the like.

Alternatively, the program of this embodiment may further be stored (recorded) temporarily or permanently in removable recording media such as a flexible disk, a CD-ROM (Compact Disc Read Only Memory), an MO (Magnet Optical) disc, a DVD (Digital Versatile Disc), a Blu-ray Disc, a magnetic disc, a semiconductor memory, and a memory card. The above-mentioned removable recording media may be supplied as so-called package software.

Further, the program according to the embodiment of the present invention may be installed from removable recording media to a computer apparatus and the like, or may be downloaded from a download site via a network such as a LAN (Local Area Network) or the Internet.

Further, the program of this embodiment is suitable for implementation and wide provision of the video data processing apparatus and the authoring system implementing the processing of this embodiment.

1. A video data processing apparatus, comprising:
an encoder configured to compression-encode input uncompressed video data, to thereby generate compressed video data; and
a synthesis processor configured
to uncompression-decode the compressed video data generated by the encoder, to thereby obtain decoded video data having a time range,
to obtain uncompressed video data of a time range same as the time range of the decoded video data, and
to generate synthesized video data in which a video image of the decoded video data and a video image of the uncompressed video data are displayed in sync with each other and in parallel to each other on one display screen.

2. The video data processing apparatus according to claim 1, wherein
the synthesis processor supplies the synthesized video data to a display apparatus to be displayed.

3. The video data processing apparatus according to claim 1, wherein
the synthesis processor supplies the synthesized video data to a storage to be stored.

4. The video data processing apparatus according to claim 3, further comprising:
a division synthesis processor configured
to read the synthesized video data stored in the storage,
to synthesize part of the video image of the decoded video data and part of the video image of the uncompressed video data in the read synthesized video data, to generate division-synthesized video data in which the parts are merged, and
to supply the division-synthesized video data to the display apparatus to be displayed.

5. A video data processing method, comprising:
compression-encoding uncompressed video data, to thereby generate compressed video data; and
uncompression-decoding the compressed video data obtained in the encoding step, to thereby obtain decoded video data having a time range, and generating synthesized video data in which a video image of the decoded video data and a video image of the uncompressed video data of a time range same as the time range of the decoded video data are displayed in sync with each other and in parallel to each other on one display screen.

6. A program causing an arithmetic processing unit to execute:
an encoding step of compression-encoding uncompressed video data, to thereby generate compressed video data; and
a synthesis processing step of uncompression-decoding the compressed video data obtained in the encoding step, to thereby obtain decoded video data having a time range, and generating synthesized video data in which a video image of the decoded video data and a video image of the uncompressed video data of a time range same as the time range of the decoded video data are displayed in sync with each other and in parallel to each other on one display screen.
